(19) United States
(12) Patent Application Publication
(10) Pub. No.: US 2002/0126877 A1
(43) Pub. Date: Sep. 12, 2002

(54) Light transmission type image recognition device and image recognition sensor

(76) Inventors: Yukihiro Sugiyama, Toride (JP); Kazuhide Sugimoto, Tsukuba (JP)

Correspondence Address: SMITH, GAMBRELL & RUSSELL, LLP, 1850 M STREET, N.W., SUITE 800, WASHINGTON, DC, 20036, US

(21) Appl. No.: 10/091,509

(22) Filed: Mar. 7, 2002

(30) Foreign Application Priority Data
Mar. 8, 2001 (JP) 2001-064681
Sep. 20, 2001 (JP) 2001-287047
Sep. 20, 2001 (JP) 2001-287048

(51) Int. Cl. G06K 9/00

(52) U.S. Cl. 382/107; 382/199

(57) ABSTRACT

A light transmission type image recognition device comprises a first transparent substrate having a plurality of transparent pixel electrodes formed in a two-dimensional array on its surface, a second transparent substrate having a transparent faced electrode formed on its surface, and a visual pigment similar protein oriented film layer and a transparent insulating layer which are arranged between both the electrodes.

### BACKGROUND OF THE INVENTION

1. Field of the Invention

The present invention relates to a light transmission type image recognition device using a visual pigment similar protein and an image recognition sensor.

Furthermore, the present invention relates to a contour detecting apparatus and method for detecting the contour of a moving object at high speed on the basis of an image recognition device using a visual pigment similar photoelectric protein and a moving object region detecting apparatus and method for detecting a moving object region at high speed on the basis of an image recognition device using a visual pigment similar photoelectric protein.

2. Description of the Prior Art

[1] It is impossible for image capturing devices having CCD (Charge Coupled Device) or CMOS (Complementary Metal-Oxide Semiconductor) as a basis and image recognition sensors using a technique for fabricating the image capturing devices as a basis to transmit light due to the limits of materials therefor.

If image recognition sensors capable of transmitting input images can be developed, the image recognition sensors can be arranged halfway in optical systems of normal cameras for capturing video, and features related to moving objects in the video can be extracted by the image recognition sensors in parallel with capturing the video by the cameras.

An object of the present invention is to provide a light transmission type image recognition device capable of transmitting an input image.

Another object of the present invention is to provide an image recognition sensor so adapted that the result of image recognition of a plurality of types of images which differ in optical characteristics can be obtained simultaneously.

[2] It has been known that electric potential is generated in portions, corresponding to contour portions where luminance in light information is changed by feeding light information, of films in which visual pigment similar photoelectric proteins, for example, bacteriohodopsin are highly oriented.

The applicants of the present invention have developed a moving object detection device as shown in FIG. 20 (see JP-A-2000-267223). The moving object detection device comprises a first substrate 1121 having a plurality of pixel electrodes 1122 formed in a two-dimensional array on its surface, a second substrate 1111 having a faced electrode 1112 formed on its surface, and a dielectric film 1130 arranged between both the electrodes 1122 and 1112. A purple membrane oriented film 1113 including bacteriohodopsin (a visual pigment similar photoelectric protein) is formed on a surface of the faced electrode 1112.

The oriented film 1113 is irradiated with light information (a moving image) from the side of the second substrate 1111. A current which is induced by electric polarization of the oriented film 1113 is detected in the pixel electrodes 1122.

The moving object detection device using the visual pigment similar photoelectric protein is for outputting as primary initial image information a current output from each of the pixel electrodes outputted by the result of photoelectric transfer of the visual pigment similar photoelectric protein arranged by molecular orientation control on a pixel electrode array. That is, the primary initial image information is a time series signal (an analog signal) output from pixel electrodes arranged in a two-dimensional manner.

The waveform of the time series signal output from each of the pixel electrodes depends on the photoelectric transfer characteristics of the visual pigment similar photoelectric protein, and the time series signal represents a differential response waveform, as indicated by a solid line in FIG. 21, by irradiation of the moving object detection device with light.

Specifically, when the visual pigment similar photoelectric protein is irradiated with light, an output current steeply increases, and is gradually attenuated with an elapse of a time period. When the irradiation of light is stopped, an output current having an opposite polarity to that in the case where light is irradiated is generated, and gradually increases with an elapse of a time period. A dotted line in FIG. 21 indicates an output current in a case where light continues to be irradiated.

In a case where an input image is a moving image including a moving object, differential response features are detected as a time series change in a contour line of the moving object. When the input image is a moving image as shown in FIG. 22a, for example, the value of a current which is induced in each of the pixel electrodes 1122 in the moving object detection device becomes a value having a positive polarity at a front end of the moving object, a value having a negative polarity at a rear end of the moving object, and an intermediate value therebetween in an inner part of the moving object, as ideally shown in FIG. 22b.

At the photoelectric transfer speed of bacteriohodopsin (a visual pigment similar photoelectric protein) constituting the oriented film 1113, however, a time constant of the exponential fall is relatively as low as 0.1 to 0.5 second irrespective of the fact that the initial response speed of the exponential rise is high. Accordingly, an afterimage is detected because of the long response tail. When the waveform of an output signal of the moving object detection device is used as it is, therefore, the contour of the moving object cannot be detected in real time (30 frames/sec.), and the contour itself is difficult to accurately recognize.

An object of the present invention is to provide a contour information detecting apparatus and method capable of detecting the accurate contour of a moving object at high speed on the basis of an image recognition device using a visual pigment similar photoelectric protein.

Another object of the present invention is to provide a moving object region detecting apparatus and method capable of detecting an accurate region of a moving object at high speed on the basis of an image recognition device using a visual pigment similar photoelectric protein.

### SUMMARY OF THE INVENTION

A light transmission type image recognition device according to the present invention is characterized by comprising a first transparent substrate having a plurality of transparent pixel electrodes formed in a two-dimensional array on its surface; a second transparent substrate having a transparent faced electrode formed on its surface; and a visual pigment similar protein oriented film layer and a transparent insulating layer which are arranged between both the electrodes.

An example of the visual pigment similar protein oriented film layer is a bacteriohodopsin oriented film layer.

An image recognition sensor according to the present invention is characterized in that a plurality of light transmission type image recognition devices are arranged in the direction in which light is incident, and an optical filter is arranged between the adjacent light transmission type image recognition devices, so that images which differ in optical characteristics are respectively input to the light transmission type image recognition devices.

An example of the optical filter is an attenuation filter for reducing the optical density of light transmission. In this case, images which have different intensity variance are respectively input to the light transmission type image recognition devices.

An example of the optical filter is a filter for changing the direction of light paths. In this case, images which differ in focal length are respectively input to the light transmission type image recognition devices.

An example of the optical filter is a soft focus filter. In this case, images which differ in resolution are respectively input to the light transmission type image recognition devices.

An example of the optical filter is a chromatic aberration correction filter. In this case, images which differ in chromatic aberration are respectively input to the light transmission type image recognition devices.

An example of the optical filter is a distortion aberration correction filter. In this case, images which differ in distortion aberration are respectively input to the light transmission type image recognition devices.

Examples of the optical filters are optical filters for transmitting light beams having different wavelengths which are not less than a predetermined wavelength. The lowest values of the wavelengths of the light beams which are respectively transmitted by the optical filters increase in the order arranged from the first stage. In this case, images which differ in wavelength region are respectively input to the light transmission type image recognition devices.

In the light transmission type image recognition device according to the present invention, the input image can be transmitted.

Furthermore, in the image recognition sensor according to the present invention, the results of the image recognition corresponding to the plurality of types of images which differ in optical characteristics are obtained simultaneously.

A contour detecting apparatus according to the present invention is a moving object contour detecting apparatus for detecting the contour of a moving object on the basis of a differential response type time series signal output from each of pixel electrodes in a moving object detection device using a visual pigment similar photoelectric protein, characterized by comprising first means for calculating a time differential value of the time series signal output from each of the pixel electrodes; second means for comparing the time differential value obtained by the first means with a threshold value for leading edge detection and a threshold value for trailing edge detection; and third means for deciding whether an image input to the pixel electrode is a leading edge of the moving object, a trailing edge of the moving object, or others on the basis of the result of the comparison by the second means.

A contour detecting method according to the present invention is a moving object contour detecting method for detecting the contour of a moving object on the basis of a differential response type time series signal output from each of pixel electrodes in a moving object detection device using a visual pigment similar photoelectric protein, characterized by comprising a first step of calculating a time differential value of the time series signal output from each of the pixel electrodes; a second step of comparing the time differential value obtained in the first step with a threshold value for leading edge detection and a threshold value for trailing edge detection; and a third step of deciding whether an image input to the pixel electrode is a leading edge of the moving object, a trailing edge of the moving object, or others on the basis of the result of the comparison in the second step.

A moving object region detecting apparatus according to the present invention is a moving object region detecting apparatus for detecting a moving object region on the basis of a differential response type time series signal output from each of pixel electrodes in a moving object detection device using a visual pigment similar photoelectric protein, characterized by comprising first means for calculating a time differential value of the time series signal output from each of the pixel electrodes; second means for comparing the time differential value obtained by the first means with a threshold value for leading edge detection and a threshold value for trailing edge detection; third means for deciding whether an image input to the pixel electrode is a leading edge of the moving object, a trailing edge of the moving object, or others on the basis of the result of the comparison by the second means; and fourth means for deciding whether or not the image input to the pixel electrode is in a moving object region on the basis of the result of the decision by the third means.

An example of the fourth means is one for deciding whether or not the image input to the pixel electrode is in a moving object region on the basis of the result of the decision by the third means and the previous result of the decision by the fourth means, and the result of the decision indicating that the image input to the pixel electrode is not in the moving object region is used as an initial value of the previous result of the decision by the fourth means.

A moving object region detecting method according to the present invention is a moving object region detecting method for detecting a moving object region on the basis of a differential response type time series signal output from each of pixel electrodes in a moving object detection device using a visual pigment similar photoelectric protein, characterized by comprising a first step of calculating a time differential value of the time series signal output from each of the pixel electrodes; a second step of comparing the time differential value obtained in the first step with a threshold value for leading edge detection and a threshold value for trailing edge detection; a third step of deciding whether an image input to the pixel electrode is a leading edge of the moving object, a trailing edge of the moving object, or others on the basis of the result of the comparison in the second step; and a fourth step of deciding whether or not the image input to the pixel electrode is in a moving object region on the basis of the result of the decision in the third step.

An example of the fourth step is one for deciding whether or not the image input to the pixel electrode is in a moving object region on the basis of the result of the decision in the third step and the previous result of the decision in the fourth step, and the result of the decision indicating that the image input to the pixel electrode is not in the moving object region is used as an initial value of the previous result of the decision in the fourth step.

In the contour detecting apparatus and method according to the present invention, the accurate contour of the moving object can be detected on the basis of the image recognition device using the visual pigment similar photoelectric protein.

In the contour detecting apparatus and method according to the present invention, the contour of the moving object can be detected in real time (30 frames/sec) or at a speed of not less than the real time on the basis of high-speed differential response rise features at the time of photoelectric transfer of the visual pigment similar photoelectric protein.

In the moving object region detecting apparatus and method according to the present invention, an accurate region of the moving object can be detected on the basis of the image recognition device using the visual pigment similar photoelectric protein.

In the moving object region detecting apparatus and method according to the present invention, a region of the moving object can be detected in real time (30 frames/sec) or at a speed of not less than the real time on the basis of high-speed differential response rise features at the time of photoelectric transfer of the visual pigment similar photoelectric protein.

The foregoing and other objects, characteristics, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing the construction of a light transmission type image recognition device;

FIGS. 2a to 2d are process views for explaining a method of forming a visual pigment similar protein oriented film layer 3 on a first electrode substrate;

FIG. 3 is a schematic view showing that electric polarization occurs when bacteriohodopsin 1 which is one type of visual pigment similar protein is irradiated with light;

FIG. 4 is a graph showing the electric polarization features of bacteriohodopsin;

FIG. 5 is a schematic view showing an output image obtained by a light transmission type image recognition device 100 in a case where the light transmission type image recognition device 100 is irradiated with a moving image including a moving object;

FIG. 6 is a schematic view showing a first applied example of the light transmission type image recognition device;

FIG. 7 is a schematic view showing a second applied example of the light transmission type image recognition device;

FIG. 8 is a schematic view showing a third applied example of the light transmission type image recognition device;

FIGS. 9a to 9c are schematic views for explaining the operations of an image recognition sensor 300 in a case where a neutral density filter is used as an optical filter 102 in the image recognition sensor 300 shown in FIG. 8;

FIG. 10 is a schematic view for explaining the operation of an image recognition sensor 300 in a case where a filter for changing the direction of light paths is used as the optical filter 102 in the image recognition sensor 300 shown in FIG. 8;

FIGS. 11a to 11d are schematic views showing examples of images input to light transmission type image recognition devices 100a to 100d in the image recognition sensor 300 shown in FIG. 10;

FIG. 12 is a schematic view showing a fourth applied example of the light transmission type image recognition device;

FIG. 13 is a graph showing the wavelength-transmittance characteristics of each of optical filters 102_1 to 102_(m−1) in FIG. 12;

FIG. 14 is a block diagram showing the configuration of a moving object detecting apparatus;

FIG. 15 is a schematic view showing the configuration of a moving object detection device;

FIG. 16 is a flow chart showing the procedure for processing of contour detection means;

FIG. 17 is a flow chart showing the procedure for processing of moving object region detection means;

FIGS. 18a to 18c are timing charts showing a specific example of an input signal f(t), contour information edg(t) obtained by contour detection means with respect to the input signal f(t), and moving object region information lbl(t) obtained by moving object region detection means with respect to the input signal f(t);

FIGS. 19a to 19c are schematic views showing a specific example of an input image, the result of detection of the contour of a moving object by contour detection means 13, and the result of detection of a moving object region by the moving object region detection means 14;

FIG. 20 is a schematic view showing the configuration of a moving object detection device which has already been developed by the applicant of the present invention;

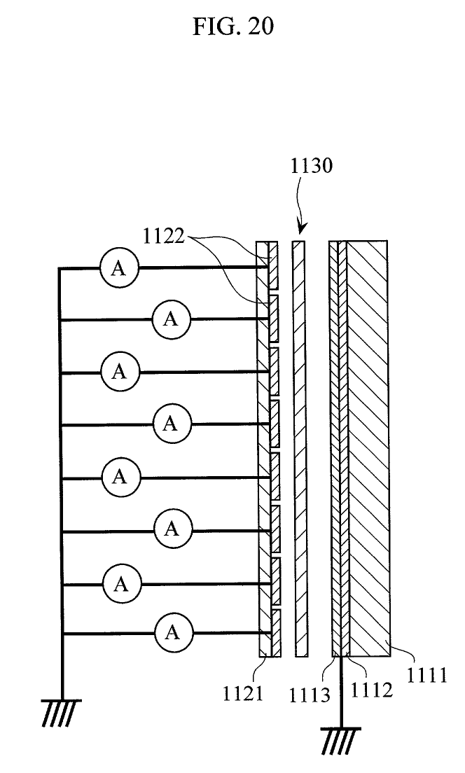

FIG. 21 is a waveform diagram showing the waveform of a time series signal output from a pixel electrode in a moving object detection device; and

FIGS. 22a and 22b are schematic views showing an input image and an example of an image detected by a moving object detection device.

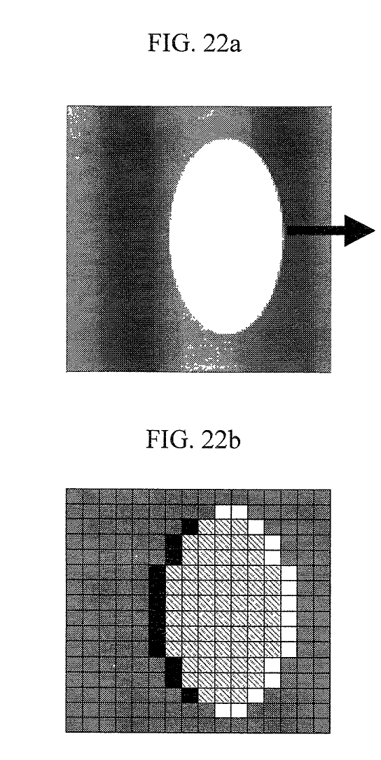

### DESCRIPTION OF THE PREFERRED EMBODIMENTS

[A] Description of Embodiment Relating Light Transmission Type Image Recognition Device and Image Recognition Sensor

[1] Description of Construction of Light Transmission Type Image Recognition Device

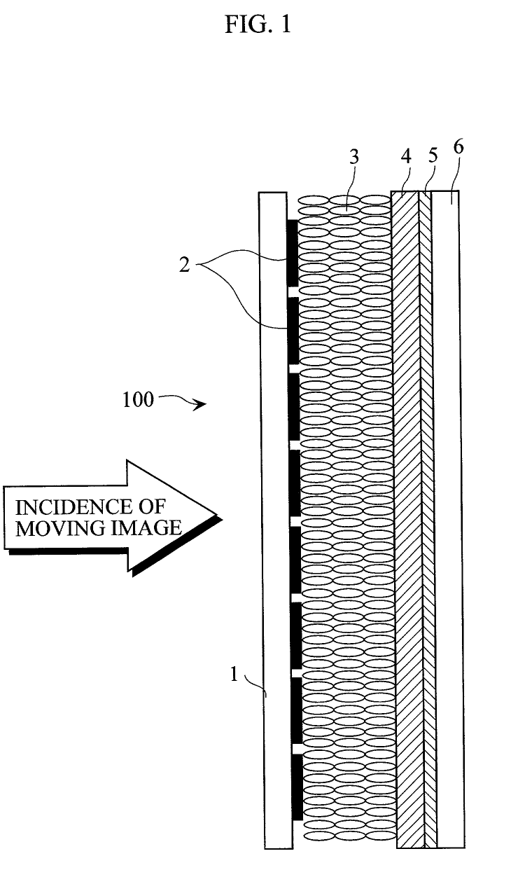

FIG. 1 illustrates the construction of a light transmission type image recognition device.

The light transmission type image recognition device 100 comprises a first substrate 1 having pixel electrodes 2 formed in a two-dimensional array on its surface, a second substrate 6 having a faced electrode 5 formed on its surface, and a visual pigment similar protein oriented film layer 3 and a transparent electrical insulating layer 4 which are arranged between both the electrodes. The visual pigment similar protein oriented film layer 3 is formed on the side of the pixel electrodes 2, and the electrical insulating layer 4 is formed on the side of the faced electrode 5.

In the light transmission type image recognition device 100, a moving object image may be projected on the visual pigment similar protein oriented film layer 3 from the side of the first substrate 1 or may be projected on the visual pigment similar protein oriented film layer 3 from the side of the second substrate 6. Here, it is assumed that the moving object image is projected on the visual pigment similar w protein oriented film layer 3 from the side of the first substrate 1.

A transparent substrate such as a transparent glass substrate is used as the first substrate 1. A light transmissible conductive layer such as ITO (Indium Tin Oxide) is used as the pixel electrode 2 formed on the first substrate 1. An example of a material for wiring formed on the first substrate 1 is a low-resistive conductive material such as Au, Au/Cr, or Cu.

A transparent substrate such as a transparent glass substrate is used as the second substrate 6. Further, a light transmissible conductive layer such as ITO is used as the faced electrode 5.

A BR (Bacteriohodopsin) oriented film layer is used as the visual pigment similar protein oriented film layer 3 in this example. Examples of the transparent insulating layer 4 are a polymeric ultra thin film and a polyimide LB (Langmuir-Blodgett) film. The faced electrode 5 is grounded. Each of the pixel electrodes 2 is connected to current detection means through the wiring on the first substrate 1.

When the moving image is projected on the visual pigment similar protein oriented film layer 3 from the side of the first substrate 1, an induced current which has been induced by electric polarization of the visual pigment similar protein oriented film layer 3 is detected in the pixel electrode 2.

The positions of the visual pigment similar protein oriented film layer 3 and the electrical insulating layer 4 may be opposite to each other. That is, the visual pigment similar protein oriented film layer 3 may be formed on the side of the faced electrode 5, and the electrical insulating layer 4 may be formed on the side of the pixel electrodes 2.

The light transmission type image recognition device 100 according to the present embodiment is characterized in that it can transmit an input image because a material for the light transmission type image recognition device 100 is transparent.

[2] Description of Method of Fabricating Light Transmission Type Image Recognition Device

In order to fabricate a light transmission type image recognition device, a first electrode substrate having pixel electrodes 2 and wiring formed on a first substrate 1 is fabricated first. Similarly, a second electrode substrate having a faced electrode 5 formed on a second substrate 6 is formed. A visual pigment similar protein oriented film layer 3 is formed on the first electrode substrate.

A transparent insulating layer 4 is formed on a surface of the visual pigment similar protein oriented film layer 3 formed on the first electrode substrate or the faced electrode 5 on the second electrode substrate. The first electrode substrate and the second electrode substrate are fixed to each other in a state where the transparent insulating layer 4 and the faced electrode 5 are pressed against each other.

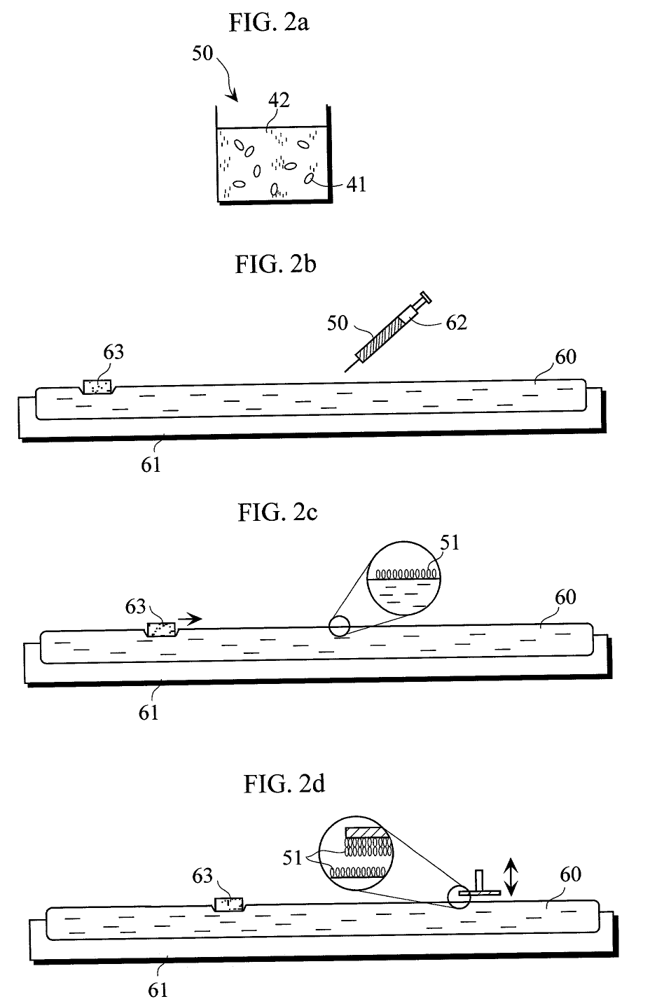

Referring now to FIGS. 2a to 2d, a method of forming the visual pigment similar protein oriented film layer 3 on the first electrode substrate in which the pixel electrode 2 and wiring are formed on the first substrate 1

(1) Preparation of visual pigment similar protein spreading solution (preparation of visual pigment similar protein monomolecular interface film)

As shown in FIG. 2a, bacteriohodopsin 41 which is a visual pigment similar protein is first dispersed in an organic solvent 42 which is not easy to denature, to prepare a protein spreading solution 50. An example of the organic solvent is a 33% solution of dimethylformamide.

The denaturation of a protein means that the function of the protein is lost by the unfold of a protein molecular structure, for example. It is also called deactivation of a protein.

(2) Spreading of visual pigment similar protein As shown in FIG. 2b, the protein spreading solution 50 is quietly spread by a syringe 62 or the like on a surface of a subphase solution 60 with which a Langumuir trough (a water trough) 61 is filled, to prepare a monomolecular layer of a protein on the surface of the subphase solution 60. At this time, molecules of the protein forming the monomolecular layer are oriented in approximately the same direction by the effect of the interfacial tension of the subphase solution 60. An example of the subphase solution 60 is demineralized water which has been adjusted to an acidic pH.

(3) Compression of visual pigment similar protein monomolecular interface film

As shown in FIG. 2c. a protein monomolecular interface film 51 prepared on the surface of the subphase solution 60 is then compressed to have a predetermined area or predetermined surface pressure by a movable barrier 63 of the Langumuir trough. When the visual pigment similar protein is bacteriohodopsin, the surface pressure is compressed into 15 mN/m.

The surface pressure generally means one-dimensional pressure, and is expressed by a force per unit length. The protein monomolecular interface film 51 is formed in a sheet shape on the surface of the subphase solution. When the protein monomolecular interface film 51 is compressed by the movable barrier 63, a one-dimensional force is interacted along the width of the film. Here, the surface pressure indicates a value obtained by dividing the one-dimensional length in the transverse direction of the protein monomolecular interface film, on which the force is exerted, by the force.

(4) Deposition of visual pigment similar protein monomolecular interface films

The protein monomolecular interface film 51 prepared on the surface of the subphase solution 60 is compressed to have a predetermined area or predetermined surface pressure, and then waits until an organic solvent included in the protein spreading solution volatilizes. However, a protein has the property of being gradually denatured even by interfacial tension exerted on the liquid surface. Consequently, a waiting time period must be set to a suitable time period such that the protein monomolecular interface film 51 is not deactivated by a balance of a time period required for the organic solvent in the protein spreading solution to volatilize and the speed of progress of the denaturation by the interfacial tension. When the visual pigment similar protein is bacteriohodopsin, the waiting time period is approximately 10 minutes.

The deposition of the visual pigment similar protein monomolecular interface films 51 in the first electrode substrate in which the pixel electrode 2 and the wiring are formed on the first substrate 1 is performed by repeating a horizontal transfer method, as shown in FIG. 2d.

Description is now made of a method of forming the transparent insulating layer 4. When the transparent insulating layer 4 is formed on the faced electrode 5 in the second electrode substrate, the faced electrode 5 is spin-coated with an electrical insulating material such as polyimide, thereby forming the transparent insulating layer on the faced electrode 5.

When the transparent insulating layer 4 is formed on a surface of the visual pigment similar protein oriented film layer 3 formed on the first electrode substrate, it is necessary not to deactivate the visual pigment similar protein oriented film layer 3. A polymer such as polyimide is formed on the surface of the visual pigment similar protein oriented film layer 3 as a multi-layer film of monomolecular films using an LB method, for example.

[3] Description of Electric Polarization Features of Visual Pigment Similar Protein

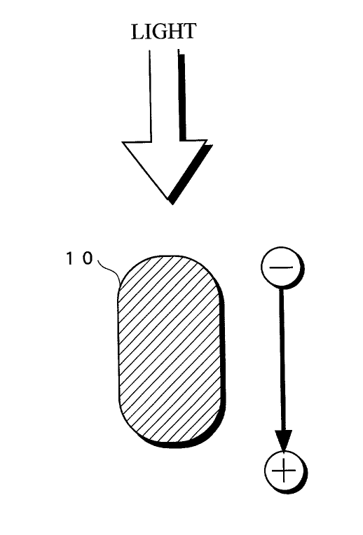

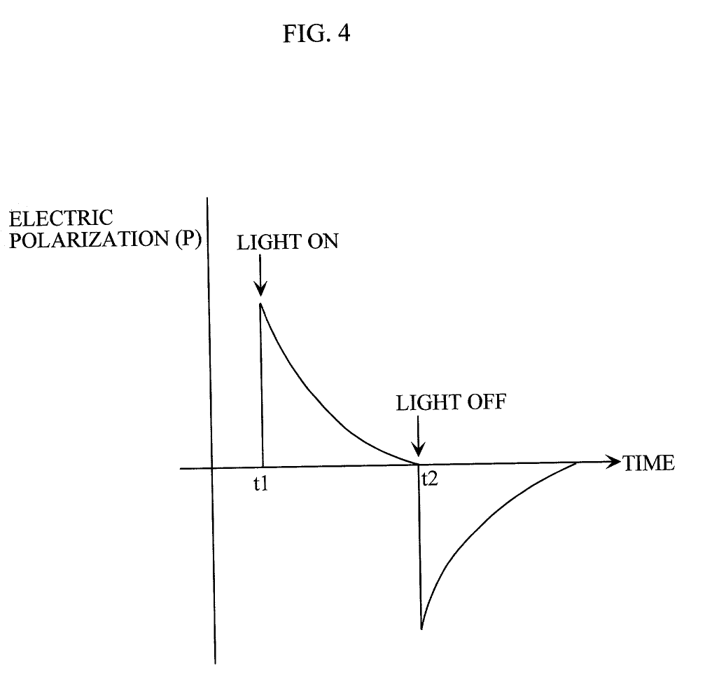

When bacteriohodopsin 1 is irradiated with light, as shown in FIG. 3, electric polarization occurs. The electric polarization features are as shown in FIG. 4. That is, when light is irradiated (time point t1), electric polarization occurs, and the electric polarization is gradually attenuated with an elapse of time. When the irradiation of light is stopped (time point t2), there occurs electric polarization having an opposite polarity to that in the case where light is irradiated, and the electric polarization is gradually attenuated with an elapse of time.

[4] Description of Operations of Light Transmission Type Image Recognition Device

The contour of a moving object in an image is extracted by taking a data difference between continuous frame images which are acquired by an input device such as a CCD. The method utilizes the fact that the difference between the two continuous frame images is generally caused by a portion corresponding to the contour of the moving object in the image.

In the light transmission type image recognition device 100 (see FIG. 1) according to the present embodiment, the contour of the moving object can be extracted without taking the data difference. Further, if a pixel value extracted by the light transmission type image recognition device 100 is constant, the contour becomes primary data at the time of detecting optical flow as it is if it is tracked.

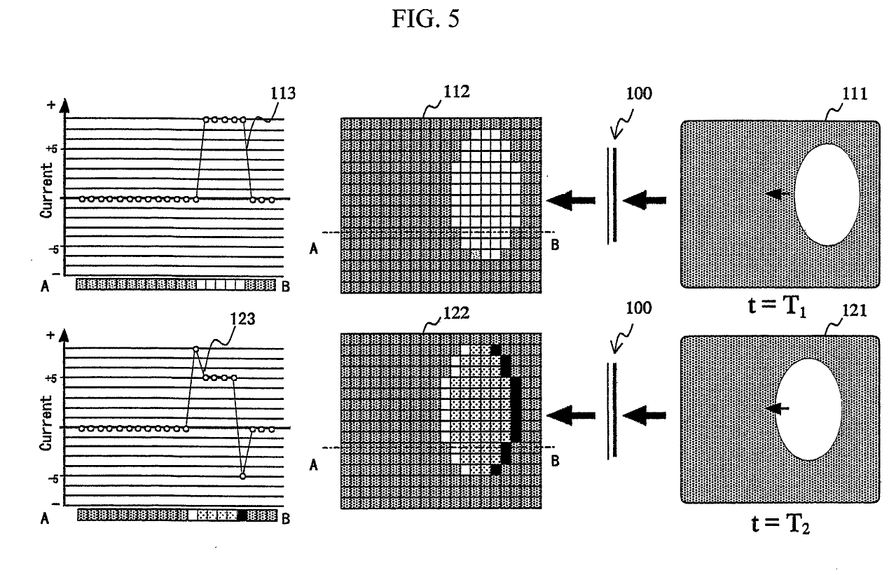

FIG. 5 illustrates an output image obtained by the light transmission type image recognition device 100 in a case where the light transmission type image recognition device 100 is irradiated with a moving image including a moving object.

In FIG. 5, reference numeral 111 denotes an input image at a time point t=T1, reference numeral 112 denotes an output image, of the light transmission type image recognition device 100, corresponding to the input image 111, and reference numeral 113 denotes an output current value of the light transmission type image recognition device 100 on a horizontal line indicated by a straight line AB in the output image 112. Here, it is assumed that the light transmission type image recognition device 100 is first irradiated with light from the moving object at the time point t=T1.

In FIG. 5, reference numeral 121 denotes an input image (light information) at a time point t=T2, reference numeral 122 denotes an output image, of the light transmission type image recognition device 100, corresponding to the input image 121, and reference numeral 123 denotes an output current value of the light transmission type image recognition device 100 on a horizontal line indicated by a straight line AB in the output image 122.

At the time point t=T1, an induced current having a predetermined value Current+8 depending on the light intensity of the moving object is generated in the pixel electrode 2 corresponding to a portion which is irradiated with light from the moving object by the electric polarization features (see FIG. 4) of the visual pigment similar protein oriented film layer 3 in the light transmission type image recognition device 100.

At the time point t=T2, \mathring{1} an induced current having a predetermined value Current+8 is generated in the pixel electrode 2 corresponding to a portion which is newly irradiated with light from the moving object. \mathring{2} An induced current to the pixel electrode 2 corresponding to the portion which is irradiated with light from the moving object subsequently from the time point t=T1 takes a lower value Current+5 than the predetermined value Current+8 by the electric polarization features (see FIG. 4) of the visual pigment similar protein oriented film layer 3 in the light transmission type image recognition device 100. \mathring{3} An induced current to the pixel electrode 2 corresponding to a portion which was irradiated with light from the moving object at the time point t=T1 but is not irradiated with light from the moving object at the time point t=T2, is changed into a predetermined value Current −5 having an opposite polarity corresponding to the light intensity of the moving object by the electric polarization features (see FIG. 4) of the visual pigment similar protein oriented film layer 3.

Consequently, the value of the induced current corresponding to the portion which is newly irradiated with light from the moving object (the contour at the front end in the motion direction of the moving object) becomes a fixed value Current+8 depending on the light intensity of the moving object. The value of the induced current corresponding to the portion which is not irradiated with light from the moving object (the contour at the back end in the motion direction of the moving object) becomes a fixed value Current−5 depending on the light intensity of the moving object.

In a case where the moving object is thus detected using the light transmission type image recognition device 100, if the luminance of the background is constant, the value of the induced current of the contour thereof is fixed. Further, both the values of induced currents corresponding to a portion which continues to be irradiated with light from the moving object and the portion which has not been irradiated with the light become Current0 with an elapse of time.

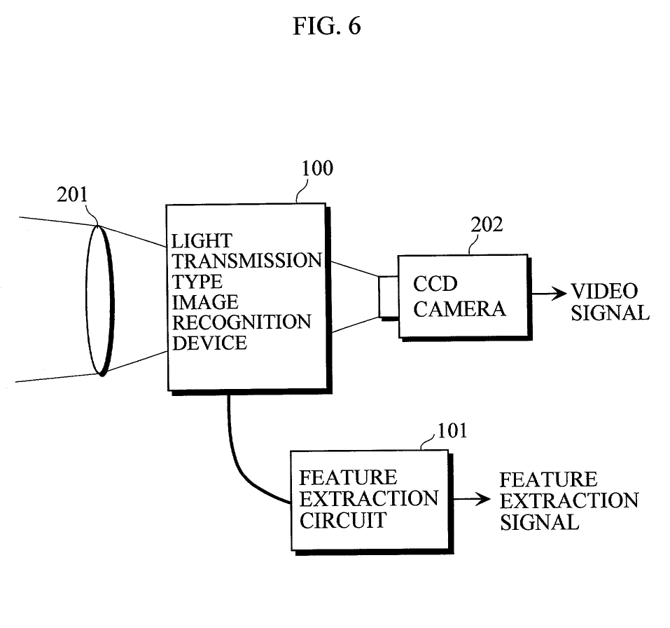

An image in the contour of the moving object which has been extracted by a data difference method is a difference image, while an image in the contour of the moving object which has been extracted by the light transmission type image recognition device 100 is a real image. Even if the background of the input moving image is a complicated image having a pattern, therefore, only the contour of the moving object in the moving image can be extracted so long as it is a still image. Further, the motion direction of the moving object can be also extracted.

[5] Description of Applied Examples

[5-1] Description of First Applied Example FIG. 6 illustrates the configuration of an image capturing system with a moving object detection function.

In FIG. 6, reference numeral 201 denotes a lens, reference numeral 202 denotes a CCD camera, reference numeral 100 denotes a light transmission type image recognition device, and 101 denotes a feature extraction circuit of a moving object.

The light transmission type image recognition device 100 is arranged between the lens 201 and the CCD camera 202. The feature extraction circuit 101 extracts the features (the contour and the motion direction) of a moving object on the basis of an output of the image recognition device 100.

In the image capturing system with a moving object detection function, it is possible to capture an image by the CCD camera 202 as well as to automatically extract features related to the moving object in the input image by the light transmission type image recognition device 100 and the feature extraction circuit 101.

When a conventional image recognition device is employed, an optical system for separately forming a video input path (an optical system) for a CCD camera and a video input path (an optical system) for an image recognition device is required. When the light transmission type image recognition device 100 is employed, however, the video input path for a CCD camera and the video input path for an image recognition device need not be separately formed, resulting in lowered cost.

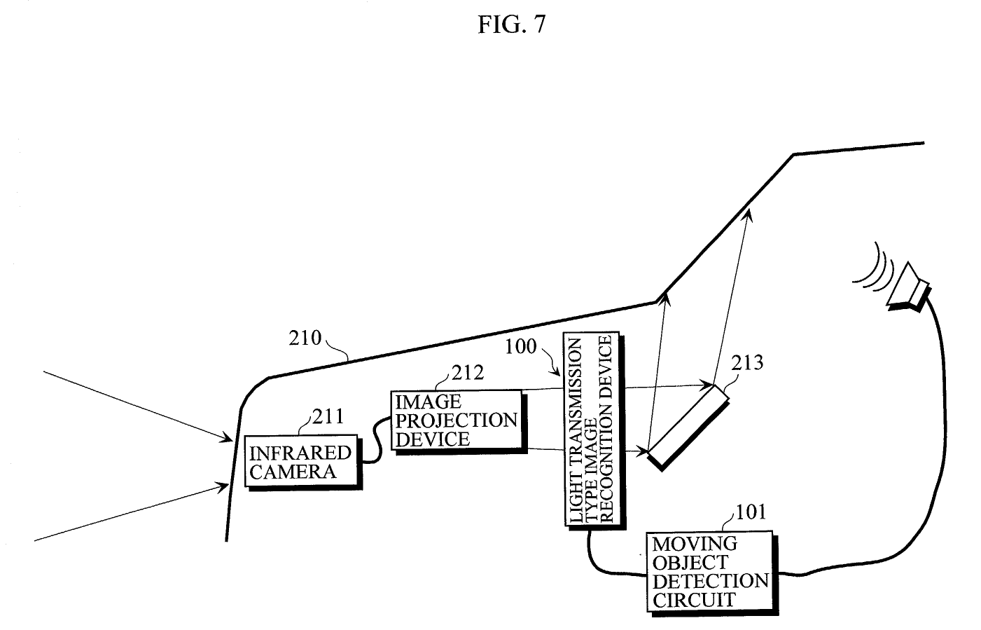

If the features related to the moving object are calculated on the basis of an output signal of the CCD camera 200, the light transmission type image recognition device 100 is not required. However, the amount of processing thereof is increased.

[5-2] Description of Second Applied Example FIG. 7 illustrates an example of application to a vehicle night infrared camera system.

The vehicle night infrared camera system has been put to practical use. The vehicle night infrared camera system is a system for a driver of an automobile judging on the basis of an output of an infrared camera the presence or absence of obstacles or a walker existing further ahead of a dead angle at which no headlight is irradiated and a portion which is irradiated with a headlight at night and informing the driver of the presence or absence.

In FIG. 7, reference numeral 210 denotes an automobile, reference numeral 211 denotes an infrared camera, 212 denotes an image projection device within a visible wavelength, reference numeral 100 denotes a light transmission type image recognition device, and reference numeral 213 denotes a mirror. Reference numeral 101 denotes a moving object detection circuit for detecting a moving object and outputting a warning sound on the basis of an output of the image recognition device 100.

The vehicle night infrared camera system comprises the infrared camera 211, the image projection device 212, and the mirror 213. That is, the infrared camera 211 senses heat (infrared rays) . An output of the infrared camera 211 is fed to the image projection device 212. The image projection device 212 projects infrared video which has been captured by the infrared camera 211. The infrared video which has been projected by the image projection device 212 is projected on a windshield of the automobile 210 through the mirror 213. The driver sees the infrared video which has been projected on the windshield, to sense and avoid the danger in advance.

In such a vehicle night infrared camera system, the judgment of conditions based on the infrared video which has been projected on the windshield is left to only the vision of the driver. Accordingly, the driver may miss the danger.

When the light transmission type image recognition device 100 is arranged on an optical path of the image projection device 212 and the mirror 213, as shown in FIG. 7, it is possible to automatically detect the moving object in the infrared video which has been captured by the infrared camera 211 by the light transmission type image recognition device 100 and the moving object detection circuit 101 and alert the driver of the moving object by the warning sound. Therefore, the driver easily senses the danger, and can drive the automobile more safely.

[5-3] Description of Third Applied Example

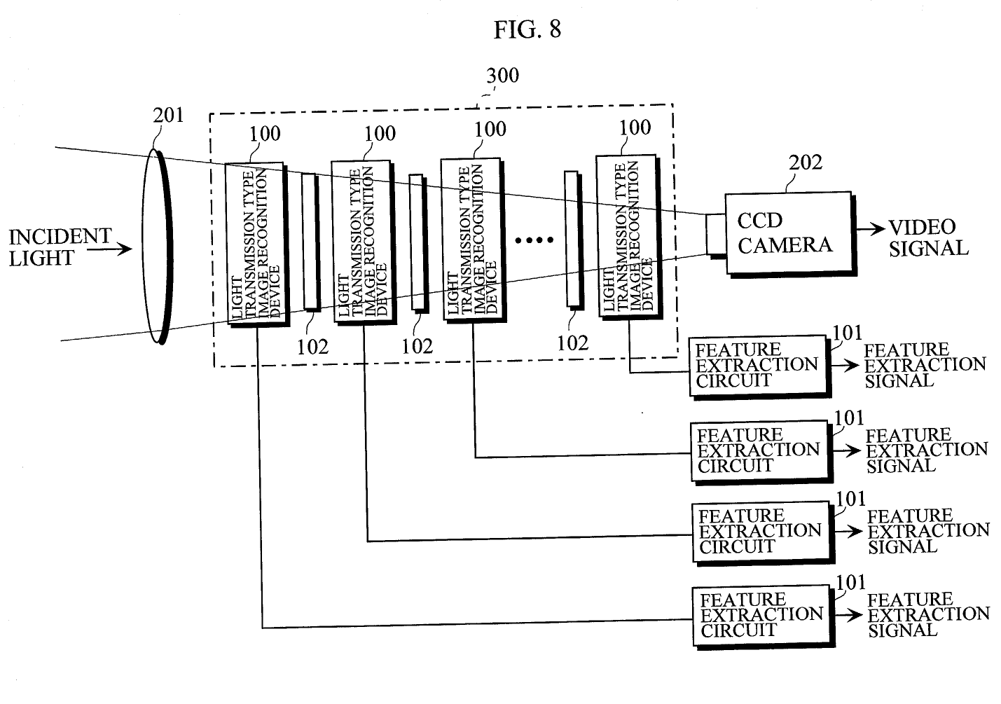

FIG. 8 illustrates the configuration of an image capturing system with a moving object detection function.

In FIG. 8, reference numeral 201 denotes a lens, reference numeral 202 denotes a CCD camera, reference numeral 300 denotes an image recognition sensor, and 101 denotes a feature extraction circuit of a moving object. The image recognition sensor 300 is arranged between the lens 201 and the CCD camera 202. The image recognition sensor 300 comprises a plurality of light transmission type image recognition devices 100 arranged side by side in the direction in which light is incident and an optical filter 102 arranged between the adjacent light transmission type image recognition devices 100.

In the following description, the light transmission type image recognition devices 100 are called ones in the first stage, the second stage, . . . in the direction away from the lens 201. The feature extraction circuit 101 is provided for each of the light transmission type image recognition devices 100. Each of the feature extraction circuits 101 extracts the features (the contour and the motion direction) of a moving object on the basis of an output image of the corresponding light transmission type image recognition device 100.

In the image capturing system with a moving object detection function, an image is captured by the CCD camera 202, and output images having different optical characteristics are respectively obtained from the light transmission type image recognition devices 100. Further, from each of the feature extraction circuits 101, features related to a moving object included in the image input to the corresponding light transmission type image recognition device 100 is automatically extracted.

It is possible to use as the optical filter 102 in the image recognition sensor 300 various types of optical filters. A typical specific example of the optical filter 102 will be described below.

[5-3-1] Description of case where attenuation filter for reducing optical density of light transmission (hereinafter referred to as neutral density filter (ND filter)) is used as optical filter 102

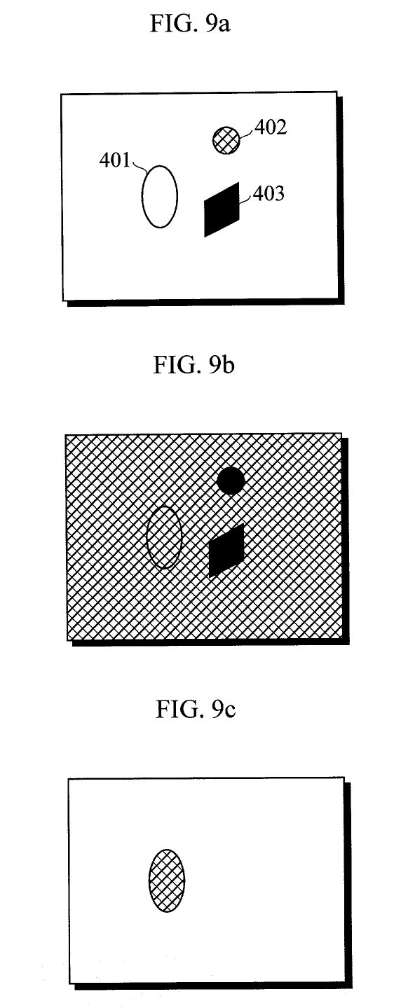

For example, it is assumed that an input image corresponding to the light transmission type image recognition device 100 in the first stage has an intensity distribution as shown in FIG. 9a. Here, the intensity of the first object 401 is the highest, the intensity of a third object 403 is the lowest, and the intensity of a second object 402 is intermediate therebetween.

Light whose density of incidence is reduced by the (n−1) ND filters 102 is incident on the light transmission type image recognition device 100 in the n-th stage behind the light transmission type image recognition device in the first stage. Accordingly, an image having an intensity distribution as shown in FIG. 9b is input. In this example, it is assumed that the intensity of the second and third objects 402 and 403 are lower than a predetermined threshold value, and only the first w object 401 has a intensity which is not less than the predetermined threshold value.

Consequently, the feature extraction circuit 101 corresponding to the light transmission type image recognition device 100 in the n-th stage extracts only features related to the object 401, as shown in FIG. 9c. That is, the features related to the objects which have intensity not less than each of the different threshold values can be extracted from respective sets of light transmission type image recognition devices 100 and feature extraction circuits 101.

When the ND filter is used as the optical filter 102, images which have different intensity variance (images having different irises) are respectively input to the light transmission type image recognition devices 100. As a result, features related to the moving objects can be extracted respectively according to the differences of intensity by the feature extraction circuits 101.

[5-3-2] Description of case where filter (polarizing filter, aspherical lens, or lens) for changing direction of light paths is used as optical filter 102

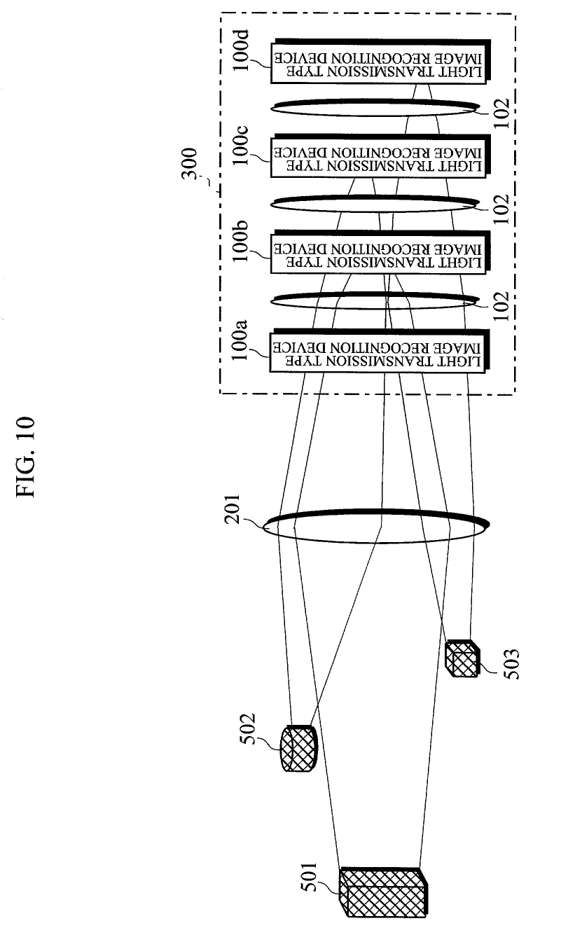

For example, it is assumed that three objects 501, 502, and 503 exist ahead of a lens 201, as shown in FIG. 10. In this example, it is assumed that the distance between the lens 201 and the first object 501 is the longest, the distance between the lens 201 and the third object 503 is the shortest, and the distance between the lens 201 and the second object 502 is intermediate therebetween out of the distances between the lens 201 and the objects 501, 502, and 503.

In FIG. 10, reference numeral 300 denotes an image recognition sensor, 100a to 100d denote light transmission type image recognition devices, and 102 denotes a filter for changing the direction of light paths.

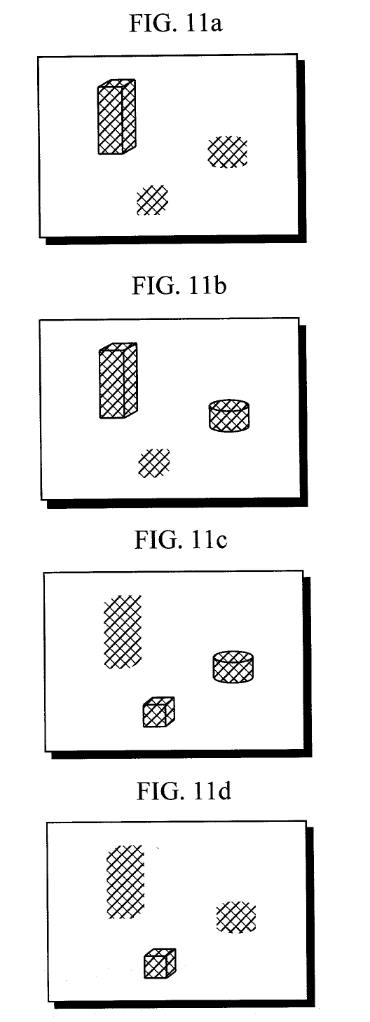

An image which is focused at a long distance (a long-distance focused image) as shown in FIG. 11a is input to the light transmission type image recognition device 100a in the first stage. Consequently, features suitable for a first object (an image corresponding to the object 501) can be obtained from the feature extraction circuit 101 corresponding to the light transmission type image recognition device 10a in the first stage.

An image which is focused at middle and long distances (an middle/long-distance focused image) as shown in FIG. 11b is input to the light transmission type image recognition device 100b in the second stage. Consequently, features suitable for a first object (an image corresponding to the object 501) and a second object (an image corresponding to the object 502) can be obtained from the feature extraction circuit 101 corresponding to the light transmission type image recognition device 100b in the second stage.

An image which is focused at middle and short distances (a middle/short-distance focused image) as shown in FIG. 11c is input to the light transmission type image recognition device 100c in the third stage. Consequently, features suitable for a second object (an image corresponding to the object 502) and a third object (an image corresponding to the object 503) can be obtained from the feature extraction circuit 101 corresponding to the light transmission type image recognition device 100c in the third stage.

An image which is focused at a short distance (a short-distance focused image) as shown in FIG. 11d is input to the light transmission type image recognition device 100d in the fourth stage. Consequently, features suitable for a third object (an image corresponding to the object 503) can be obtained from the feature extraction circuit 101 corresponding to the light transmission type image recognition device 100d in the fourth stage.

When the filter for changing the direction of light paths is thus used as the optical filter 102, images having different focal lengths are respectively input to the light transmission type image recognition devices 100. As a result, features related to the moving objects can be extracted respectively according to the differences of focal lengths by the feature extraction circuits 101.

[5-3-3] Description of case where blurring filter (soft focus filter) is used as optical filter 102

In the configuration shown in FIG. 8, when a blurring filter (a soft focus filter) is used as the optical filter 102, images having different resolutions are respectively input to the light transmission type image recognition devices 100. As a result, features related to the moving objects can be extracted respectively according to the differences of resolutions by the feature extraction circuits 101.

[5-3-4] Description of case where chromatic aberration correction filter is used as optical filter 102

In the configuration shown in FIG. 8, when a chromatic aberration correction filter is used as the optical filter 102, images having different chromatic aberrations are respectively input to the light transmission type image recognition devices 100. As a result, features related to the moving objects can be extracted respectively according to the differences of chromatic aberrations by the feature extraction circuits 101.

[5-3-5] Description of case where distortion aberration correction filter is used as optical filter 102 in the configuration shown in FIG. 8

In the configuration shown in FIG. 8, when a distortion aberration correction filter is used as the optical filter 102, images having different distortion aberrations are respectively input to the light transmission type image recognition devices 100. As a result, features related to the moving objects can be extracted respectively according to the differences of distortion aberrations by the feature extraction circuits 101.

[5-4] Description of Fourth Applied Example

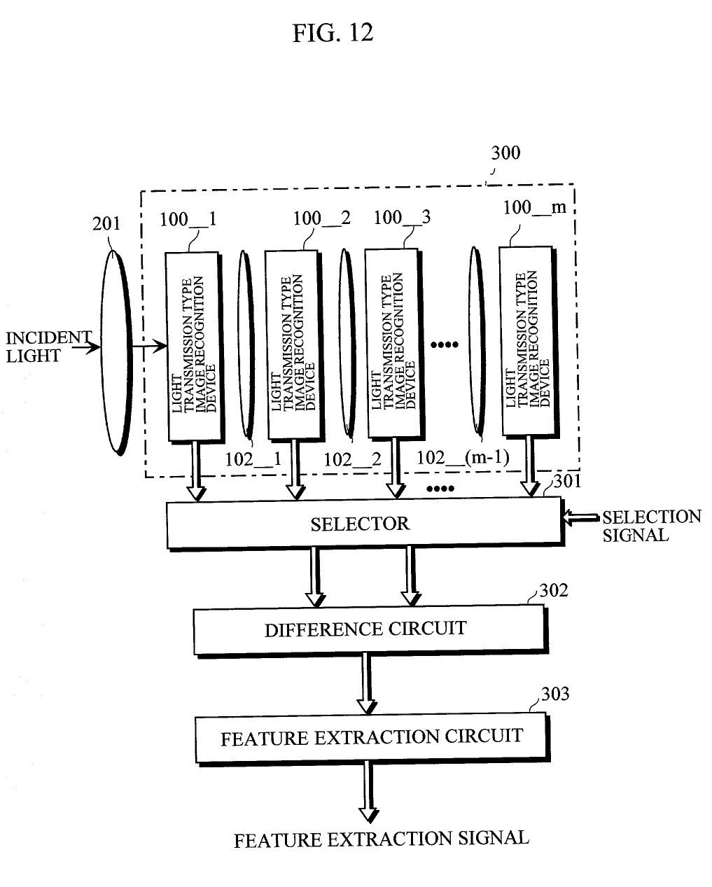

FIG. 12 illustrates the configuration of an image recognizing apparatus comprising an image recognition sensor.

In FIG. 12, reference numeral 201 denotes a lens, reference numeral 300 denotes an image recognition sensor, reference numeral 301 denotes a selector, reference numeral 302 denotes a difference circuit, and reference numeral 303 denotes a feature extraction circuit.

The image recognition sensor 300 is arranged in a stage succeeding the lens 201. The image recognition sensor 300 comprises a plurality of light transmission type image recognition devices 100_1 to 100_m arranged side by side in the direction in which light is incident and optical filters 102_1 to 102_(m−1) arranged between the adjacent light transmission type image recognition devices 100. Optical filters for transmitting light beams respectively having wavelengths which are not less than a predetermined wavelength are used as the optical filters 102_1 to 102_(m−1).

The selector 301 selects, out of output images of the light transmission type image recognition devices 100_1 to 100_m, the two output images designated by a selection signal on the basis of the selection signal input on the basis of user setting. The difference circuit 302 extracts a difference image between the two output images from the selector 301. The feature extraction circuit 303 extracts the features of a moving object on the basis of the difference image output from the difference circuit 302.

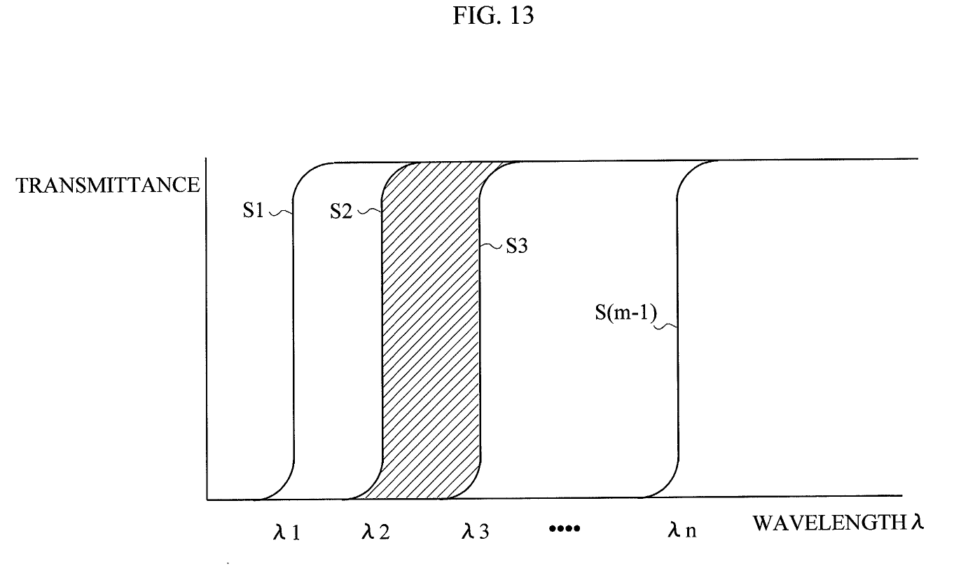

FIG. 13 illustrates wavelength-transmittance characteristics of each of the optical filters 102_1 to 102_(m−1).

In FIG. 13, curves S1, S2, S3, and S(m−1) respectively represent the characteristics of the optical filter 102_1 in the first stage, the characteristics of the optical filter 102_2 in the second stage, the characteristics of the optical filter 102_3 in the third stage, and the characteristics of the optical filter 102_(m−1) in the (m−1)-th stage.

As apparent from FIG. 13, the optical filter 102_1 in the first stage, the optical filter 102_2 in the second stage, the optical filter 102_3 in the third stage, and the optical filter 102_(m−1) in the (m−1)-th stage respectively have characteristics for transmitting light in a region of wavelengths which are not less than a wavelength λ1, characteristics for transmitting light in a region of wavelengths which are not less than a wavelength λ2 (λ2>λ 1) , characteristics for transmitting light in a region of wavelengths which are not less than a wavelength λ3 (λ3>λ 2) , and characteristics for transmitting light in a region of wavelengths which are not less than a wavelength λm−1 (λm1>λm−2).

That is, letting n be an integer from 1 to (m−1), the optical filter 102_n in the n-th stage has characteristics for transmitting light in a region of wavelengths which are not less than a wavelength λn (λn>λn−1)

In order to extract a feature of an object corresponding to the light beam in a particular wavelength of incident light to the lens 201, for example, in a wavelength between λ2 and λ3, therefore, a difference image between the output image of the light transmission type image recognition device 100_3 in the third stage and the output image of the light transmission type image recognition device 100_4 in the fourth stage may be first extracted, to extract a feature from the obtained difference image.

When optical filters for transmitting light beams having different wavelengths which are not less than a predetermined wavelength are used as the optical filter 102 in the image recognition sensor 300, therefore, a feature related to a moving object which appears in an image in a particular wavelength region is obtained from the feature extraction circuit 303.

[B] Description of Embodiment Relating Moving Object Contour Detecting Apparatus and Method and Moving Object Region Detecting Apparatus and Method

[1] Description of Configuration of Moving object Detecting Apparatus

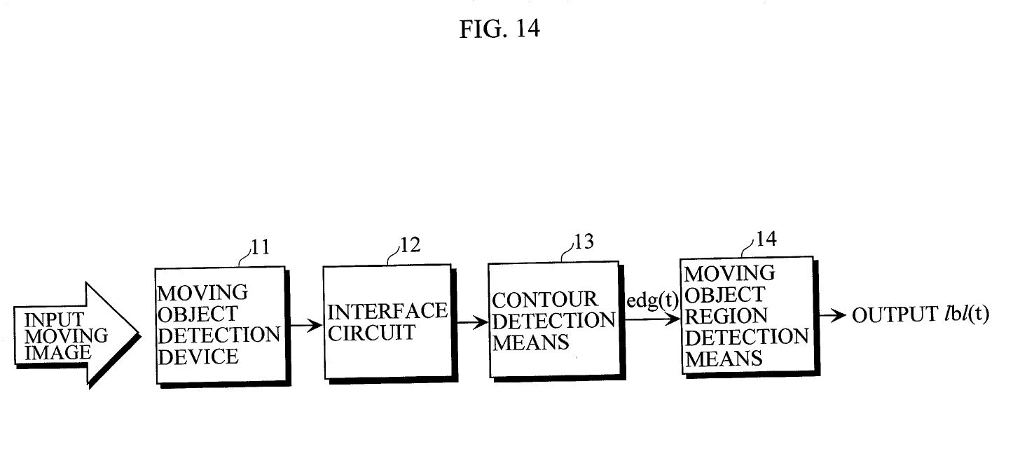

FIG. 14 illustrates the configuration of a moving object detecting apparatus.

The moving object detecting apparatus comprises a moving object detection device 11 using a visual pigment similar photoelectric protein, an interface circuit 12 for amplifying a signal output from each of pixel electrodes in the moving object detection device 11 and converting the amplified signal into a digital signal, contour detection means 13 for detecting the contour of a moving object on the basis of a signal for each of the pixel electrodes output from the interface circuit 12, and moving object region detection means 14 for detecting a moving object region on the basis of contour information detected by the contour detection means 13.

[2] Description of Construction of Moving Object Detection Device

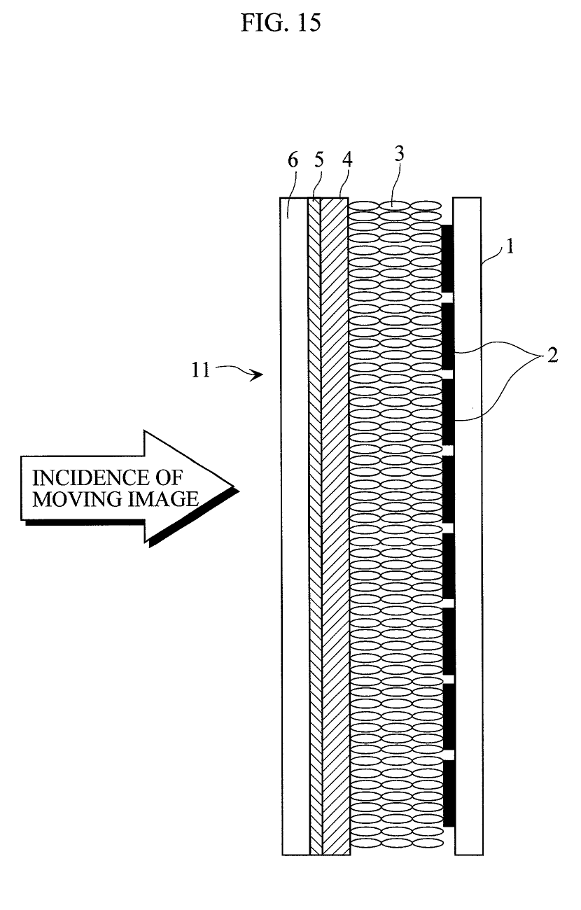

FIG. 15 illustrates the construction of the moving object detection device 11.

The moving object detection device 11 comprises a first substrate 1 having pixel electrodes 2 formed in a two-dimensional array on its surface, a second substrate 6 having a faced electrode 5 formed on its surface, a visual pigment similar protein oriented film layer 3 and an electrical insulating layer 4 which are arranged between both the electrodes. The visual pigment similar protein oriented film layer 3 is formed on the side of the pixel electrodes 2, and the electrical insulating layer 4 is formed on the side of the faced electrode 5.

In the moving object detection device 11, it is assumed that a moving image is projected on the visual pigment similar protein oriented film layer 3 from the side of the second substrate 6.

The plurality of pixel electrodes 2 and wiring connected to each of the pixel electrodes 2 are formed on the first substrate 1. An example of a material for the pixel electrode 2 and the wiring is a low-resistive conductive material such as Au, Au/Cr, or Cu.

Since the moving image is projected on the visual pigment similar protein oriented film layer 3 from the side of the second substrate 6, a transparent substrate such as a transparent glass substrate is used as the second substrate 6. Further, a light transmissible conductive layer such as ITO is used as the faced electrode 5.

A BR (Bacteriohodopsin) oriented film layer is used as the visual pigment similar protein oriented film layer 3 in this example. Examples of the electrical insulating layer 4 are a polymeric ultra thin film and a polyimide LB film. The faced electrode 5 is grounded. Each of the pixel electrodes 2 is connected to current detection means through the wiring on the first substrate 1.

When the moving image is projected on the visual pigment similar protein oriented film layer 3 from the side of the second substrate 6, an induced current is induced in each of the pixel electrodes 2 by electric polarization of the visual pigment similar protein oriented film layer 3. The induced current which has been induced in each of the pixel electrodes 2 is fed to the interface circuit 12. The interface circuit 12 amplifies a signal fed from each of the pixel electrodes 2 in the moving object detection device 11, and converts the amplified signal into a digital signal.

The moving image can be also projected on the visual pigment similar protein oriented film layer 3 from the side of the first substrate 1. In this case, a transparent substrate such as a transparent glass substrate is used as the first substrate 1. Further, a light transmissible conductive layer such as ITO is used as the pixel electrode 2 formed on the first substrate 1. An example of a material for the wiring formed on the first substrate 1 is a low-resistive conductive material such as Au, Au/Cr, or Cu.

In this case, a low-resistive conductive layer such as Au is used as the faced electrode 5 formed on the second substrate. A bacteriohodopsin oriented film layer is used as the visual pigment similar protein oriented film layer 3 in this example. Examples of the electrical insulating layer 4 are a polymeric ultra thin film and a polyimide LB film.

The positions of the visual pigment similar protein oriented film layer 3 and the electrical insulating layer 4 may be opposite to each other. That is, the visual pigment similar protein oriented film layer 3 may be formed on the side of the faced electrode 5, and the electrical insulating layer 4 may be formed on the side of the pixel electrodes 2.

[3] Description of Contour Detection Means 13

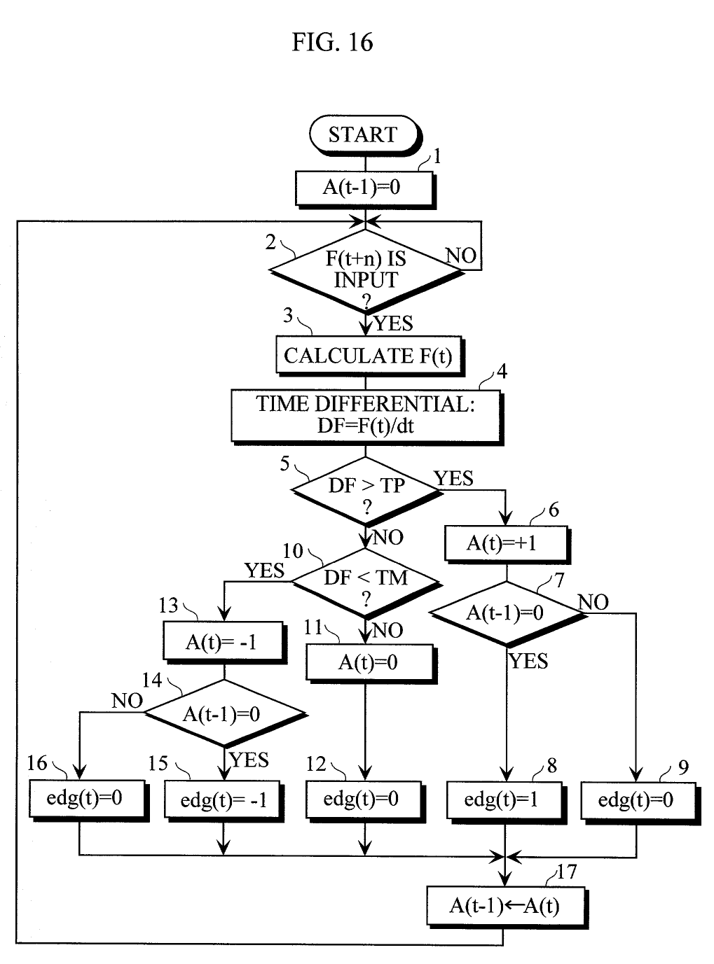

FIG. 16 illustrates a contour detection algorithm executed by the contour detection means 13. The contour detection algorithm is executed for an output signal of each of the pixel electrodes 2. Here, description is made of the contour detection algorithm executed for the one arbitrary pixel electrode 2. The present embodiment is based on the premise that a moving object region is brighter than a background region, and the number of moving object regions is one.

In the following description, f(t) is a digital signal corresponding to one arbitrary pixel electrode output from the interface circuit 12, and represents a signal value relative to time t.

F(t) represents a locally interpolated function of the time series signal f(t) in the vicinity of the time t. In this example, a function of a straight line approximating most closely to a signal train {f(t−n) , f(t-n+1), . . . f(t), . . . , f (t+n) } before and after the time t paid attention to is found by a least-squares method. The found function of the straight line is taken as F(t). “5”, for example, is used as n.

DF represents a time differential value of F(t), and is calculated on the basis of the following equation (1):

DF =dF(t)/dt (1)

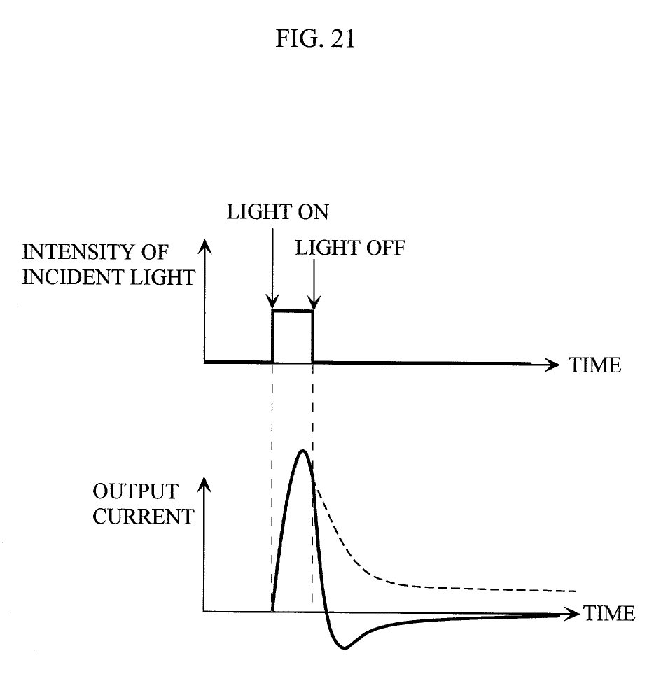

TP represents a positive threshold value corresponding to a positive differential value (a threshold value for leading edge detection). TM represents a negative threshold value corresponding to a negative differential value (a threshold value for trailing edge detection). TM is set to a value corresponding to a differential value of a most inclined portion of a fall portion of a waveform in a case where light continues to be irradiated (indicated by a broken line), assuming that the waveform of a time series signal output from the pixel electrode 2 in a case where the moving object detection device 11 shown in FIG. 15 is irradiated with light is a waveform as shown in FIG. 21.

A(t) represents the result of decision of conditions, described later, and takes a value +1, 0 or −1. A(t−1) represents the previous result of decision of conditions.

edg(t) represents contour information, and takes a value +1, 0, or −1. Edg(t) indicates that it is a leading edge of the moving object if it is +1, while indicating that it is a trailing edge of the moving object if it is −1.

Zero is first given as an initial value of A(t−1) (step 1). When f(t+n) is input (step 2), a function f(t) of a straight line approximating most closely to a signal train {f(t-n) , f(t-n+1), . . . f(t), . . . , f(t+n) } before and after the time t is calculated (step 3).

A time differential value DF corresponding to F(t) is then calculated on the basis of the foregoing equation (1) (step 4).

It is decided whether or not the time differential value DF is larger than the positive threshold value TP (step 5). When the time differential value DF is larger than the positive threshold value TP, the value of the current result of decision of conditions A(t) is set to +1 (step 6). It is decided whether or not the value of the previous result of decision of conditions A(t−1) is zero (step 7).

If the value of the previous result of decision of conditions A(t−1) is zero, it is decided that the contour information edg(t) is a leading edge of the moving object, to set the value of the contour information edg(t) to +1 and then, output the contour information edg(t) (step 8). If the value of the previous result of decision of conditions A(t−1) is not zero, it is decided that the contour information edg(t) is not an edge of the moving object, to set the value of the contour information edg(t) to zero and then, output the contour information edg(t) (step 9). When the contour information edg(t) is output, the current result of decision of conditions A(t) is stored as the previous result of decision of conditions A(t−1), after which the program is returned to the step 2.

When it is decided at the foregoing step 5 that the time differential value DF is not more than the positive threshold value TP, it is decided whether or not the time differential value DF is less than the negative threshold value TM (step 10). When the time differential value DF is not less than the negative threshold value TM, the value of the current result of decision of conditions A(t) is set to zero (step 11). Further, the value of the contour information edg(t) is set to zero, and the contour information edg(t) is then output (step 12). The current result of decision of conditions A(t) is stored as the previous result of decision of conditions A (t−1) (step 17), after which the program is returned to the step 2.

When it is decided at the foregoing step 10 that the time differential value DF is less than the negative threshold value TM, the value of the current result of decision of conditions A(t) is set to −1 (step 13). It is decided whether or not the value of the previous result of decision of conditions A(t−1) is zero (step 14).

If the value of the previous result of decision of conditions A(t−1) is zero, it is decided that the contour information edg(t) is a trailing edge of the moving object, to set the value of the contour information edg(t) to −1 and then, output the contour information edg(t) (step 15). If the value of the previous result of decision of conditions A(t−1) is not zero, it is decided that the contour information edg(t) is not an edge of the moving object, to set the value of the contour information edg(t) to zero and then, output the contour information edg(t) (step 16). When the contour information edg(t) is output, the current result of decision of conditions A(t) is stored as the previous result of decision of conditions A(t−1) (step 17), after which the program is returned to the step 2.

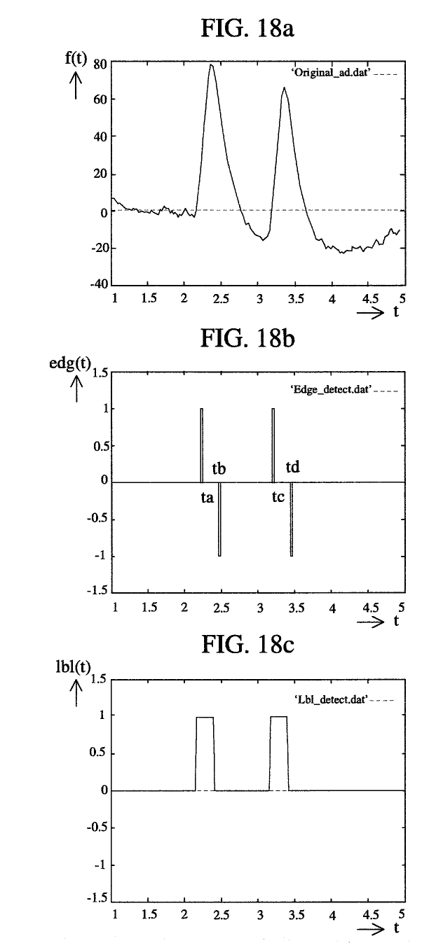

When f(t) is time series data, as shown in FIG. 18a, the contour information edg(t) is as shown in FIG. 18b. FIG. 18b shows that the leading edge of the moving object is detected at a time point ta, the trailing edge of the moving object is detected at a time point tb, the leading edge of the moving object is detected at a time point tc, and the trailing edge of the moving object is detected at a time point td.

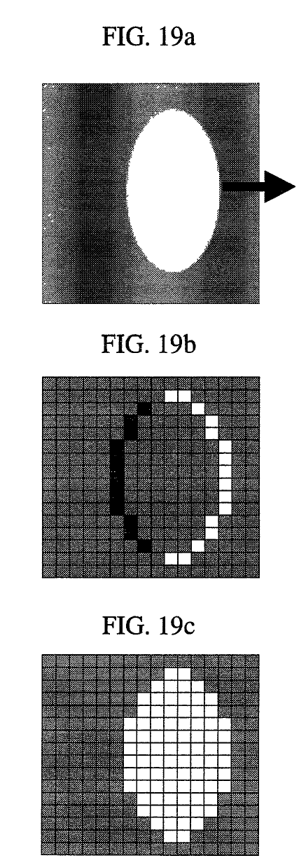

When in the input image, the moving object is a elliptical object which moves rightward, as shown in FIG. 19a, the result of detection of the contour of the moving object by the contour detection means 13 is as shown in FIG. 19b. In FIG. 19b, a white pixel represents a pixel corresponding to the contour information edg(t)=+1, and a black pixel represents a pixel corresponding to the contour information edg(t)=−1.

[4] Description of Moving Object Region Detection Means

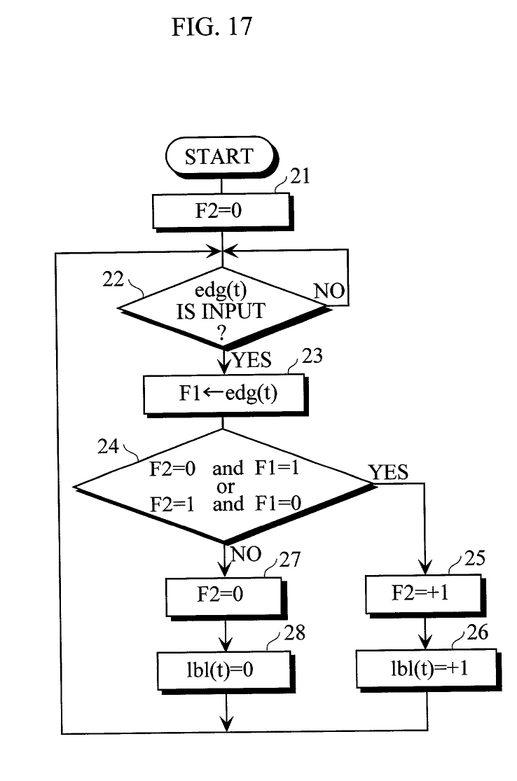

FIG. 17 illustrates a moving object region detection algorithm executed by the moving object region detection means 14. The moving object region detection algorithm is executed on the basis of contour information related to each of the pixel electrodes 2 which is output from the contour detection means 13. Here, description is made of a moving object region detection algorithm executed on the basis of the contour information related to one arbitrary pixel electrode (hereinafter referred to as a target pixel electrode) 2.

In FIG. 17, edg(t) represents edge information input from the contour detection means 13. F1 represents a flag for storing the value of the input edg(t), that is, takes a value +1, 0, or −1. F2 represents a flag for storing decision whether a region detected by the target pixel electrode is in a moving object region or a background region. F2=+1 if the region detected by the target pixel electrode is the moving object region, while F2=0 if it is the background region.

The present embodiment is based on the premise that a moving object region is brighter than a background region, and the number of moving object regions is one, as described above.

Zero is first given as an initial value of F2 (step 21). When edg(t) is input (step 22), the value of edg(t) is taken as F1 (step 23), and it is then decided whether or not the following first conditions or second conditions are satisfied (step 24).

First conditions : F2=0 and F1=1

Second conditions : F2=1 and F1=0

When the first conditions or the second conditions are satisfied, it is decided that the region detected by the target pixel electrode is the moving object region, to set the value of F2 to +1 (step 25). Further, the value of moving object region information lbl(t) is set to +1, to output lbl(t) (step 26). The program is then returned to the step 22.

When neither the first conditions nor the second conditions are satisfied at the foregoing step 24, it is decided that the region detected by the target pixel electrode is the background region, to set the value of F2 to zero (step 27). Further, the value of the moving object region information lbl(t) is set to zero, to output lbl(t) (step 28). The program is then returned to the step 22.

When f(t) is time series data, as shown in FIG. 18a, the contour information edg(t) is as shown in FIG. 18b, and the moving object region information lbl(t) is as shown in FIG. 18c.

When in the input image, the moving object is a elliptical object which moves rightward, as shown in FIG. 19a, the result of detection of the contour of the moving object by the contour detection means 13 is as shown in FIG. 19b, and the result of detection of the moving object region by the moving object region detection means 14 is as shown in FIG. 19c.

Although the present invention has been described and illustrated in detail, it is clearly understood that the same is by way of illustration and example only and is not to be taken by way of limitation, the spirit and scope of the present invention being limited only by the terms of the appended claims.

What is claimed:

1. A light transmission type image recognition device comprising:
a first transparent substrate having a plurality of transparent pixel electrodes formed in a two-dimensional array on its surface;
a second transparent substrate having a transparent faced electrode formed on its surface; and
a visual pigment similar protein oriented film layer and a transparent insulating layer which are arranged between both the electrodes.

2. The light transmission type image recognition device according to claim 1, wherein
the visual pigment similar protein oriented film layer is a bacteriohodopsin oriented film layer.

3. An image recognition sensor, wherein
a plurality of light transmission type image recognition devices according to claim 1 are arranged in the direction in which light is incident, and an optical filter is arranged between the adjacent light transmission type image recognition devices, so that images which differ in optical characteristics are respectively input to the light transmission type image recognition devices.

4. The image recognition sensor according to claim 3, wherein
the optical filter is an attenuation filter for reducing the optical density of light transmission, and
images which have different intensity variance are respectively input to the light transmission type image recognition devices.

5. The image recognition sensor according to claim 3, wherein
the optical filter is a filter for changing the direction of light paths, and
images which differ in focal length are respectively input to the light transmission type image recognition devices.

6. The image recognition sensor according to claim 3, wherein
the optical filter is a soft focus filter, and
images which differ in resolution are respectively input to the light transmission type image recognition devices.

7. The image recognition sensor according to claim 3, wherein
the optical filter is a chromatic aberration correction filter, and
images which differ in chromatic aberration are respectively input to the light transmission type image recognition devices.

8. The image recognition sensor according to claim 3, wherein
the optical filter is a distortion aberration correction filter, and
images which differ in distortion aberration are respectively input to the light transmission type image recognition devices.

9. The image recognition sensor according to claim 3, wherein
the optical filters are optical filters for transmitting light beams having different wavelengths which are not less than a predetermined wavelength,
the lowest values of the wavelengths of the light beams which are respectively transmitted by the optical filters increase in the order arranged from the first stage, and
images which differ in wavelength region are respectively input to the light transmission type image recognition devices.

10. A moving object contour detecting apparatus for detecting the contour of a moving object on the basis of a differential response type time series signal output from each of pixel electrodes in a moving object detection device using a visual pigment similar photoelectric protein, comprising:
first means for calculating a time differential value of the time series signal output from each of the pixel electrodes;
second means for comparing the time differential value obtained by the first means with a threshold value for leading edge detection and a threshold value for trailing edge detection; and
third means for deciding whether an image input to the pixel electrode is a leading edge of the moving object, a trailing edge of the moving object, or others on the basis of the result of the comparison by the second means.

11. A moving object contour detecting method for detecting the contour of a moving object on the basis of a differential response type time series signal output from each of pixel electrodes in a moving object detection device using a visual pigment similar photoelectric protein, comprising:
a first step of calculating a time differential value of the time series signal output from each of the pixel electrodes;
a second step of comparing the time differential value obtained in the first step with a threshold value for leading edge detection and a threshold value for trailing edge detection; and
a third step of deciding whether an image input to the pixel electrode is a leading edge of the moving object, a trailing edge of the moving object, or others on the basis of the result of the comparison in the second step.

12. A moving object region detecting apparatus for detecting a moving object region on the basis of a differential response type time series signal output from each of pixel electrodes in a moving object detection device using a visual pigment similar photoelectric protein, comprising:
first means for calculating a time differential value of the time series signal output from each of the pixel electrodes;
second means for comparing the time differential value obtained by the first means with a threshold value for leading edge detection and a threshold value for trailing edge detection;
third means for deciding whether an image input to the pixel electrode is a leading edge of the moving object, a trailing edge of the moving object, or others on the basis of the result of the comparison by the second means; and
fourth means for deciding whether or not the image input to the pixel electrode is in a moving object region on the basis of the result of the decision by the third means.

13. The moving object region detecting apparatus according to claim 12, wherein
the fourth means decides whether or not the image input to the pixel electrode is in a moving object region on the basis of the result of the decision by the third means and the previous result of the decision by the fourth means, and
the result of the decision indicating that the image input to the pixel electrode is not in the moving object region is used as an initial value of the previous result of the decision by the fourth means.

14. A moving object region detecting method for detecting a moving object region on the basis of a differential response type time series signal output from each of pixel electrodes in a moving object detection device using a visual pigment similar photoelectric protein, comprising:
a first step of calculating a time differential value of the time series signal output from each of the pixel electrodes;
a second step of comparing the time differential value obtained in the first step with a threshold value for leading edge detection and a threshold value for trailing edge detection;
a third step of deciding whether an image input to the pixel electrode is a leading edge of the moving object, a trailing edge of the moving object, or others on the basis of the result of the comparison in the second step; and
a fourth step of deciding whether or not the image input to the pixel electrode is in a moving object region on the basis of the result of the decision in the third step.

15. The moving object region detecting method according to claim 14, wherein
the fourth step comprises the step of deciding whether or not the image input to the pixel electrode is in a moving object region on the basis of the result of the decision in the third step and the previous result of the decision in the fourth step, and
the result of the decision indicating that the image input to the pixel electrode is not in the moving object region is used as an initial value of the previous result of the decision in the fourth step.
